(19) United States
(12) Patent Application Publication
(10) Pub. No.: US 2025/0110605 A1
(43) Pub. Date: Apr. 3, 2025

(54) SYSTEMS AND METHODS OF BOUNDARY TRANSITIONS FOR CREATIVE WORKFLOWS

(71) Applicant: Apple Inc., Cupertino, CA (US)

(72) Inventors: David H. HUANG, San Mateo, CA (US); Randal W. LAMORE, San Francisco, CA (US); Soravis PRAKKAMAKUL, Emeryville, CA (US); Valentin F. ROUSSELLET, Culver City, CA (US)

(21) Appl. No.: 18/892,109

(22) Filed: Sep. 20, 2024

Related U.S. Application Data
(60) Provisional application No. 63/586,949, filed on Sep. 29, 2023.

(51) Int. Cl. G06F 3/04815

(52) U.S. Cl. CPC G06F 3/04815

(57) ABSTRACT

Some examples of the disclosure are directed to systems and methods for displaying a boundary associated with a virtual scene. In some examples, a device displays a virtual scene concurrently with the boundary. In some examples, the device presents representations of the user's physical environment when a viewpoint of a user of the device satisfies one or more criteria associated with the boundary. In some examples, the device displays visual indications of individuals physically co-located with the user of the device.

### CROSS REFERENCE TO RELATED APPLICATIONS

This application claims the benefit of U.S. Provisional Application No. 63/586,949, filed Sep. 29, 2023, the entire disclosure of which is herein incorporated by reference for all purposes.

### FIELD OF THE DISCLOSURE

This relates generally to systems and methods of displaying virtual environments and adding virtual content to the virtual environments.

### BACKGROUND OF THE DISCLOSURE

Some computer graphical environments provide two-dimensional and/or three-dimensional environments where at least some objects presented for a user's viewing are virtual and generated by a computer. In some examples, virtual three-dimensional environments can be based on one or more images of the physical environment of the computer. In some examples, virtual three-dimensional environments do not include images of the physical environment of the computer.

### SUMMARY OF THE DISCLOSURE

Some examples of the disclosure are directed to systems and methods for presenting representations of a physical environment of a user of an electronic device and/or presenting virtual, three-dimensional environment scene to the user. In some examples, an electronic device can present and/or display a three-dimensional environment to a user of the three-dimensional environment. In some examples, the three-dimensional environment can include representations of physical objects and/or individuals. In some examples, the three-dimensional environment can include one or more virtual objects and/or virtual assets.

In some examples, the electronic device can display one or more representations of physical individuals. In some examples, the one or more representations include a representation of a user of another electronic device engaged in a communication session with the electronic device. In some examples, the electronic device displays a virtual scene that can be shared with the other electronic device. In some examples, the virtual scene is displayed as though the user of the electronic device is present within a physical equivalent of the virtual scene. In some examples, the representations of physical individuals move relative to the virtual scene.

In some examples, the electronic device displays indications of user attention within the three-dimensional environment. In some examples, the electronic device displays indications of attention corresponding to attention of other users inspecting the virtual scene. In some examples, the electronic device displays a visual indication of a boundary within the three-dimensional environment. In some examples, the electronic device maintains display of the virtual scene in accordance with a determination that a viewpoint of the user of the electronic device corresponds to a region of the three-dimensional environment within the boundary. In some examples, the electronic device displays a representation of the user's physical environment in accordance with a determination that the viewpoint of the user does not correspond to the region of the three-dimensional environment within the boundary. In some examples, the electronic device changes one or more dimensions of the boundary in accordance with user inputs. In some examples, the electronic device displays a visual indication of physical individuals while maintaining display of the virtual scene. In some examples, the electronic device displays representations of those physical individuals. In some examples, the electronic device displays representations of the physical environment of the user in accordance with a determination that the viewpoint of the user satisfies one or more criteria.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an exemplary architecture for a device according to some examples of the disclosure.

FIGS. 3A-3J illustrate example interactions including a virtual scene and a virtual border according to some examples of the disclosure.

FIG. 4 illustrates a flow diagram illustrating an example process for displaying a virtual scene and a virtual border according to some examples of the disclosure.

### DETAILED DESCRIPTION

Some examples of the disclosure are directed to systems and methods for presenting representations of a physical environment of a user of an electronic device and/or presenting virtual, three-dimensional environment scene to the user. In some examples, an electronic device can present and/or display a three-dimensional environment to a user of the three-dimensional environment. In some examples, the three-dimensional environment can include representations of physical objects and/or individuals. In some examples, the three-dimensional environment can include one or more virtual objects and/or virtual assets.

In some examples, the electronic device can display one or more representations of physical individuals. In some examples, the one or more representations include a representation of a user of another electronic device engaged in a communication session with the electronic device. In some examples, the electronic device displays a virtual scene that can be shared with the other electronic device. In some examples, the virtual scene is displayed as though the user of the electronic device is present within a physical equivalent of the virtual scene. In some examples, the representations of physical individuals move relative to the virtual scene.

In some examples, the electronic device displays indications of user attention within the three-dimensional environment. In some examples, the electronic device displays indications of attention corresponding to attention of other users inspecting the virtual scene. In some examples, the electronic device displays a visual indication of a boundary within the three-dimensional environment. In some examples, the electronic device maintains display of the virtual scene in accordance with a determination that a viewpoint of the user of the electronic device corresponds to a region of the three-dimensional environment within the boundary. In some examples, the electronic device displays a representation of the user's physical environment in accordance with a determination that the viewpoint of the user does not correspond to the region of the three-dimensional environment within the boundary. In some examples, the electronic device changes one or more dimensions of the boundary in accordance with user inputs. In some examples, the electronic device displays a visual indication of physical individuals while maintaining display of the virtual scene. In some examples, the electronic device displays representations of those physical individuals. In some examples, the electronic device displays representations of the physical environment of the user in accordance with a determination that the viewpoint of the user satisfies one or more criteria.

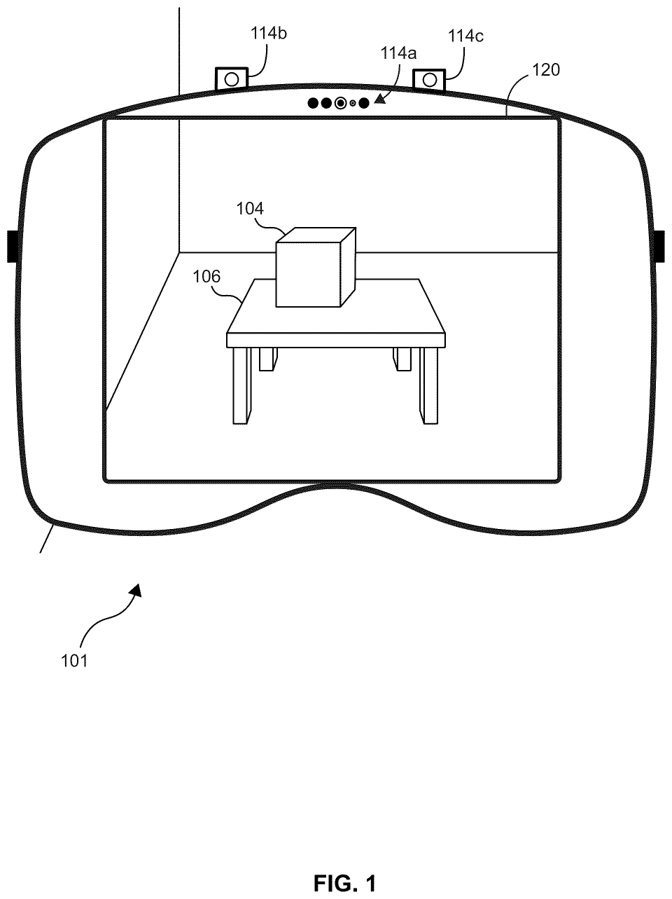

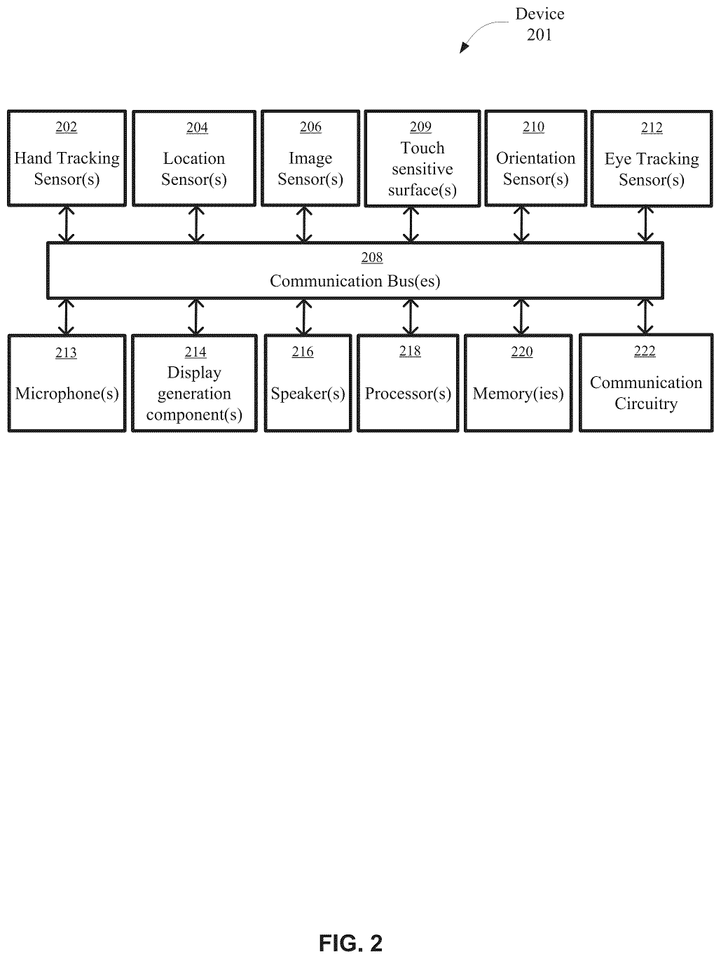

FIG. 1 illustrates an electronic device 101 presenting an extended reality (XR) environment (e.g., a computer-generated environment) according to some examples of the disclosure. In some examples, electronic device 101 is a hand-held or mobile device, such as a tablet computer, laptop computer, smartphone, or head-mounted display. Examples of device 101 are described below with reference to the architecture block diagram of FIG. 2. As shown in FIG. 1, electronic device 101, table 106, and coffee mug 132 are located in the physical environment 100. The physical environment may include physical features such as a physical surface (e.g., floor, walls) or a physical object (e.g., table, lamp, etc.). In some examples, electronic device 101 may be configured to capture images of physical environment 100 including table 106 and coffee mug 132 (illustrated in the field of view of electronic device 101). In some examples, in response to a trigger, the electronic device 101 may be configured to display a virtual object 104 (e.g., two-dimensional virtual content) in the computer-generated environment (e.g., represented by a cube illustrated in FIG. 1) that is not present in the physical environment 100, but is displayed in the computer-generated environment positioned on (e.g., anchored to) the top of a computer-generated representation 106′ of real-world table 106. For example, virtual object 104 can be displayed on the surface of the computer-generated representation 106′ of the table in the computer-generated environment next to the computer-generated representation 132′ of real-world coffee mug 132 displayed via electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional computer-generated environment. For example, the virtual object can represent an application or a user interface displayed in the computer-generated environment. In some examples, the virtual object can represent content corresponding to the application and/or displayed via the user interface in the computer-generated environment. In some examples, the virtual object 104 is optionally configured to be interactive and responsive to user input, such that a user may virtually touch, tap, move, rotate, or otherwise interact with, the virtual object 104. In some examples, the virtual object 104 may be displayed in a three-dimensional computer-generated environment with a particular orientation. In some examples, while the virtual object 104 is displayed in the three-dimensional environment, the electronic device selectively moves the virtual object 104 in response to user input (e.g., direct input or indirect input) according to the particular orientation in which the virtual object is displayed. Additionally, it should be understood, that the 3D environment (or 3D virtual object) described herein may be a representation of a 3D environment (or three-dimensional virtual object) projected or presented at an electronic device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described herein, it should be understood that the described electronic device, display and touch-sensitive surface are optionally distributed amongst two or more devices. Therefore, as used in this disclosure, information displayed on the electronic device or by the electronic device is optionally used to describe information output by the electronic device for display on a separate display device (touch-sensitive or not). Similarly, as referred to herein, input received on the electronic device (e.g., touch input received on a touch-sensitive surface of the electronic device, or touch input received on the surface of a stylus) is optionally used to describe input received on a separate input device that is communicated to and/or indicated to the electronic device.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an exemplary architecture for a device 201 according to some examples of the disclosure. In some examples, device 201 includes one or more electronic devices. For example, the electronic device 201 may be a portable device, such as a mobile phone, smart phone, a tablet computer, a laptop computer, an auxiliary device in communication with another device, a head-mounted display, etc., respectively.

As illustrated in FIG. 2, the electronic device 201 optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214, one or more speaker(s) 216, one or more processor(s) 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non- transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a GPS receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212, in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 can use image sensor(s) 206 (e.g., one or more IR cameras, 3D cameras, depth cameras, etc.) that capture three-dimensional information from the real-world including one or more hands (e.g., of a human user). In some examples, the hands can be resolved with sufficient resolution to distinguish fingers and their respective positions. In some examples, one or more image sensor(s) 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by a respective eye tracking camera/illumination source(s).

Electronic device 201 is not limited to the components and configuration of FIG. 2, but can include fewer, other, or additional components in multiple configurations. In some examples, device 201 can be implemented between two electronic devices (e.g., as a system). A person or persons using electronic device 201, is optionally referred to herein as a user or users of the device.

Virtual scenes can be used as a digital backdrop included in cinematic experiences. The virtual scenes, for example, can be used as backgrounds for chroma key compositing and/or display on light emitting diode (LED) wall arrays. Virtual scenes can also be included in immersive virtual content, such as immersive virtual scenes for virtual reality (VR), extended reality (XR), and/or mixed reality (MR) applications in which virtual assets consume at least a portion of a view of a viewer's physical environment. Editing virtual scenes, especially when the editing process is collaborative, can be cumbersome and unintuitive using conventional approaches. The present disclosure contemplates methods and systems for improving efficiency of user interaction with virtual assets included in the scene and increasing user awareness of their physical environment. One or more of the examples of the disclosure are directed to displaying a virtual border and/or boundary associated with a virtual scene via an electronic device. In one or more examples, the electronic device can display representations of the user's physical environment when a position and/or orientation of the user relative to a three-dimensional environment of the user—at times, referred to herein as a “viewpoint” of the user—corresponds to a region of the three-dimensional environment outside of the virtual border and/or boundary. In one or more examples, the electronic device can display one or more portions of the virtual scene when the user's viewpoint corresponds to a position within the virtual border and/or boundary. In one or more examples, the electronic device displaying the virtual border annotation can communicate with one or more other devices, and users of the respective devices can view visual indications of attention of other users. In one or more examples, the electronic device displays a visual indication of physical individuals that are within the user's physical environment, and display representations of the physical individuals in response to an event. In one or more examples, the electronic device displays representations of the user's physical environment replacing portions of a displayed virtual scene when criteria are satisfied, such as when the user's viewpoint changes rapidly relative to the three-dimensional environment.

Attention is now directed towards methods and systems of facilitating annotation of a virtual scene displayed in a three-dimensional environment presented at an electronic device (e.g., corresponding to electronic device 201). As described previously, it can be appreciated that extended reality (XR) editing of virtual scenes improves efficiency of user interaction when editing and inspecting the virtual scenes. In some examples, engaging a plurality of devices in a communication session to collaboratively edit and/or inspect a virtual scene improves clarity and efficiency of communication between the users of the device. Displaying a virtual border and/or boundary foreshadows display of a virtual scene and/or the user's physical environment that can occur in response to the user's viewpoint changing relative to the user's environment, thus improving user awareness of what may be presented via the electronic device, thereby improving human-computer interaction when viewing the user's physical environment and/or the virtual scenes. In some examples, the boundary corresponds to a physical region within the virtual environment. In some examples, the electronic device augments visibility of the physical region with virtual content, such as virtual content included in a virtual scene. In some examples, the boundary defines and/or includes a virtual stage area within which the virtual content is displayed, similar to a physical stage with physical set dressings.

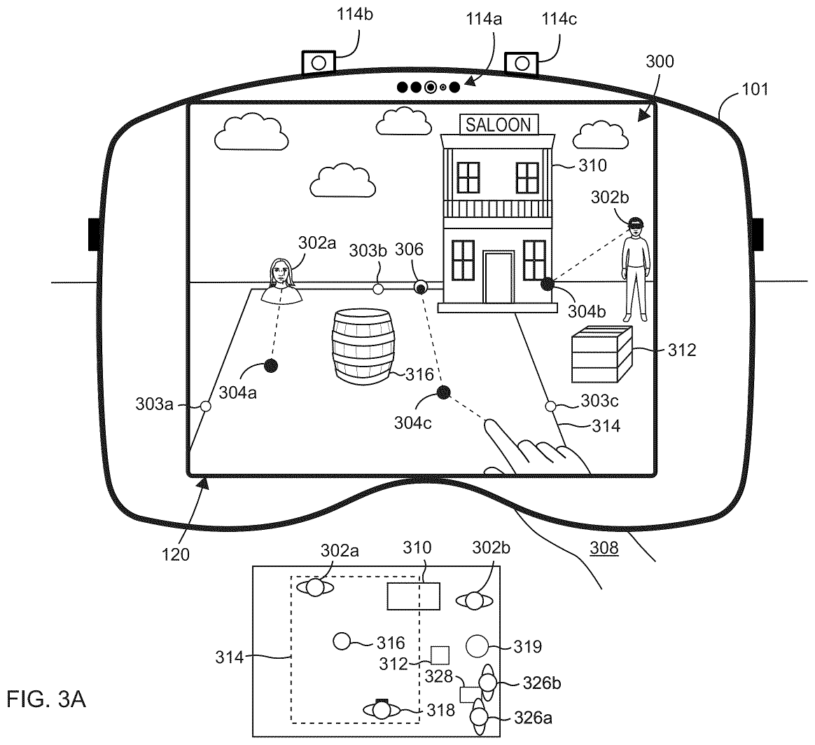

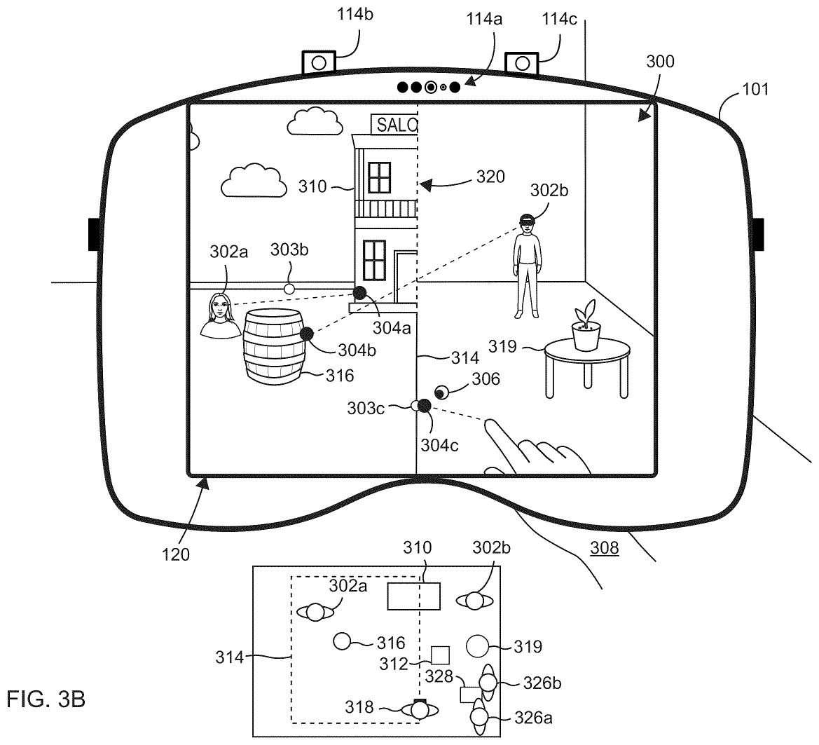

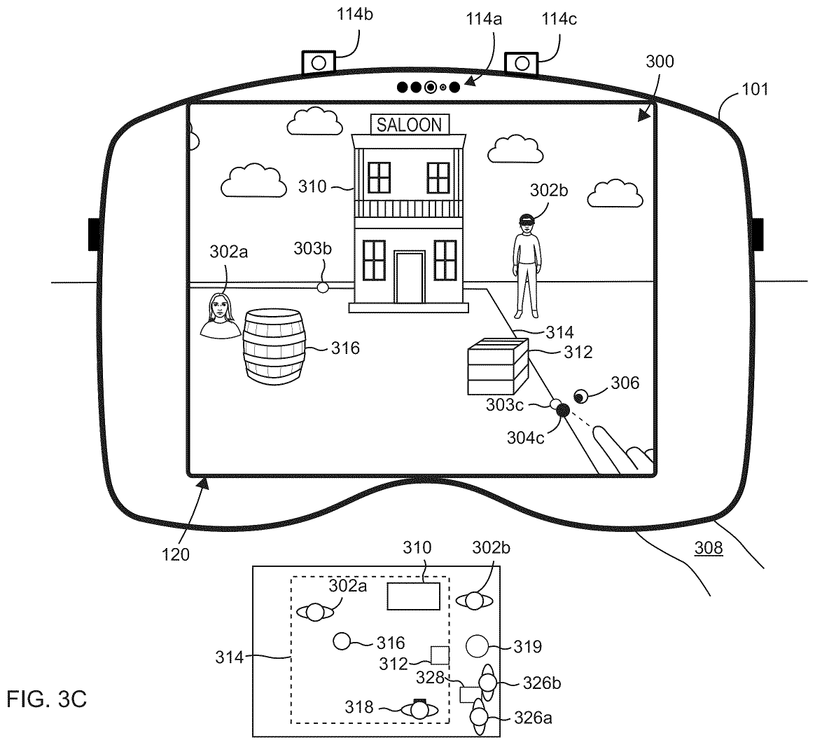

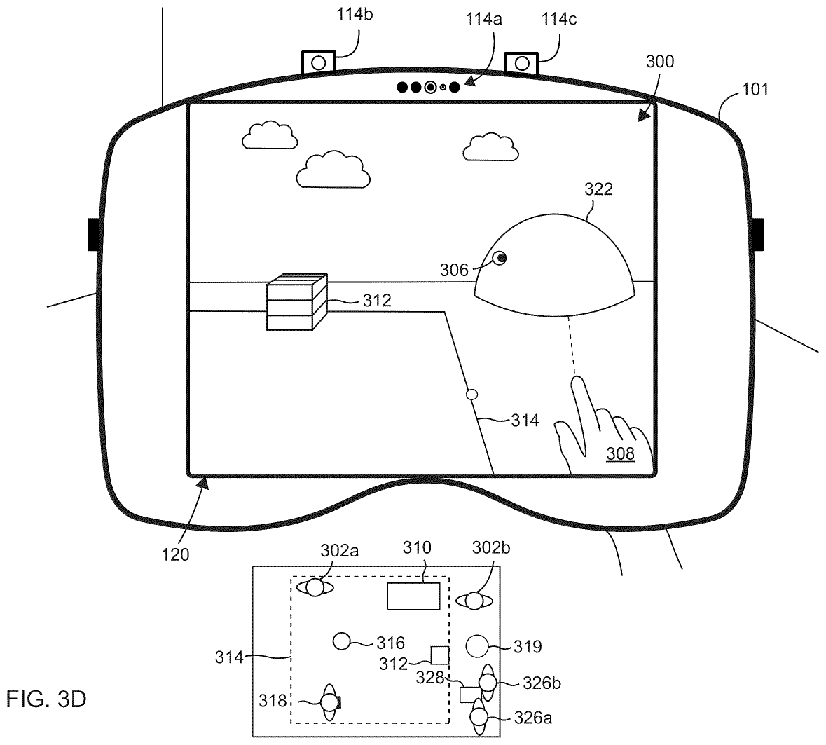

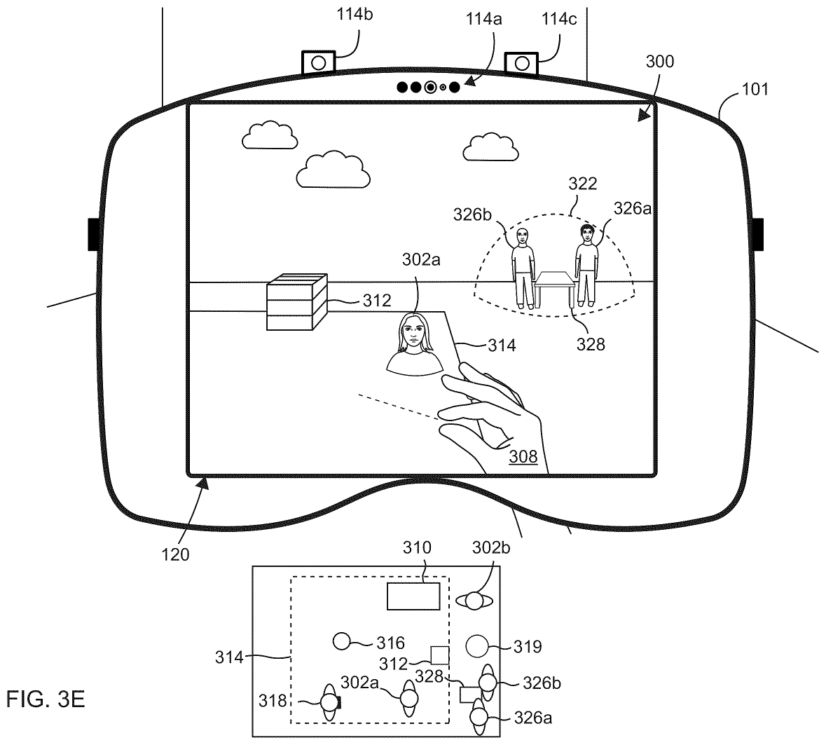

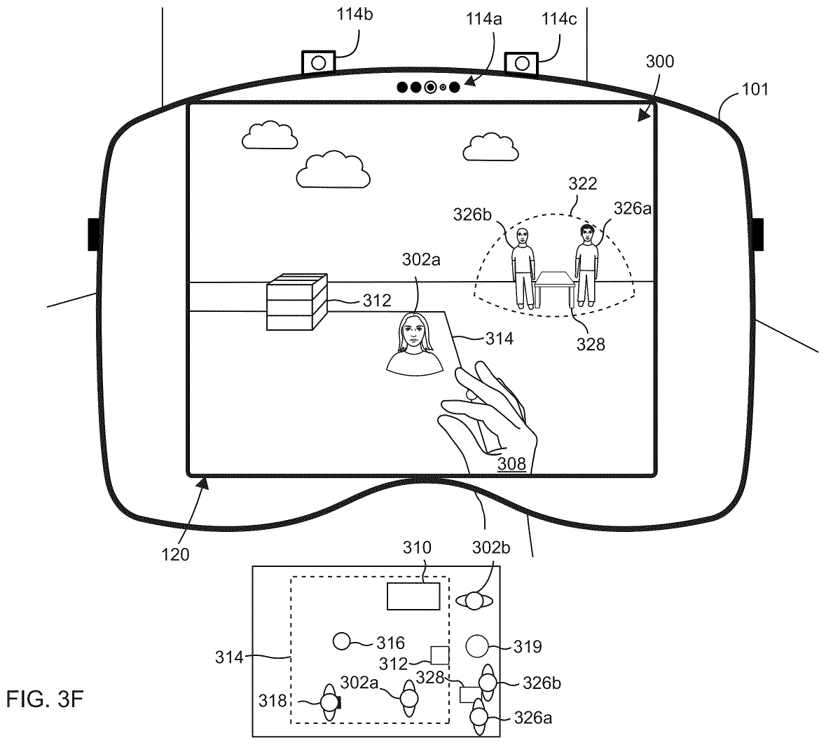

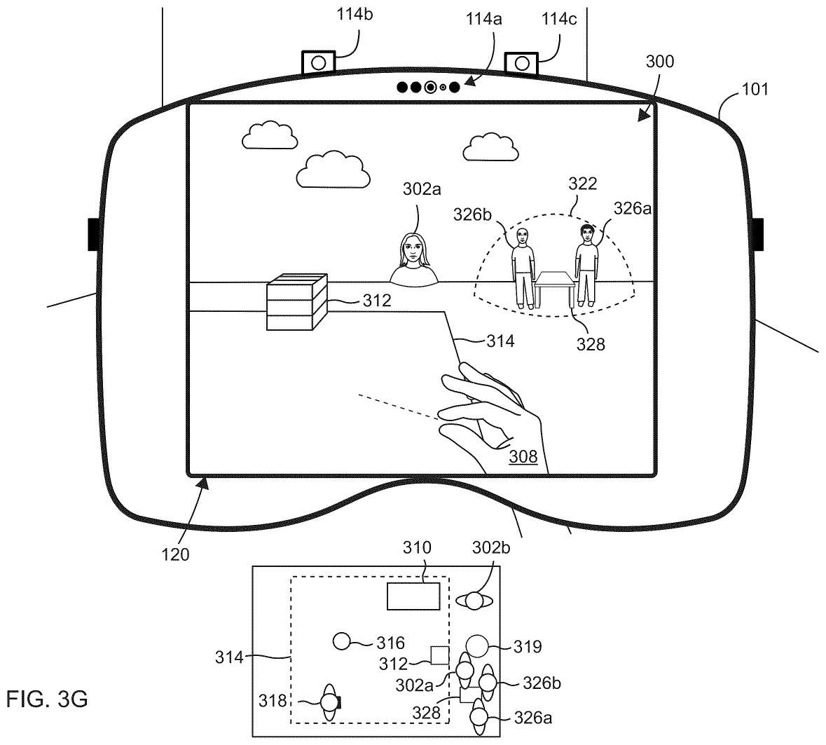

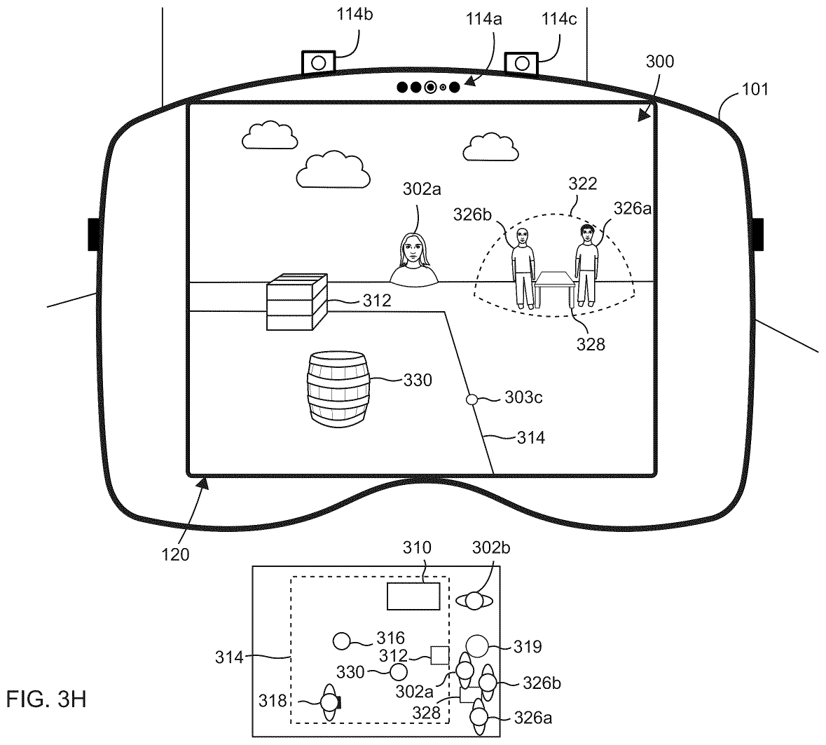

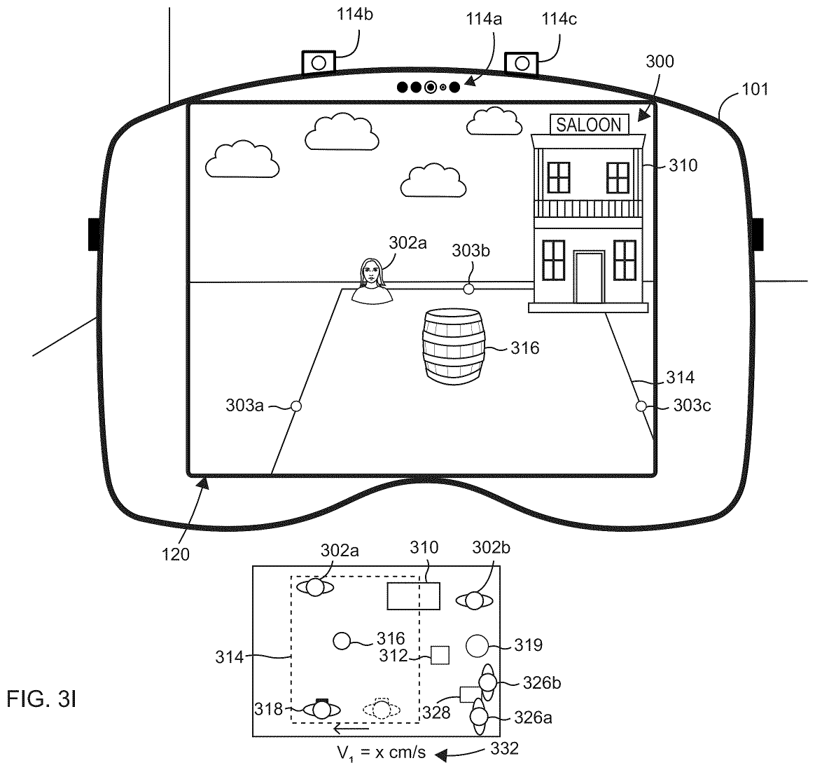

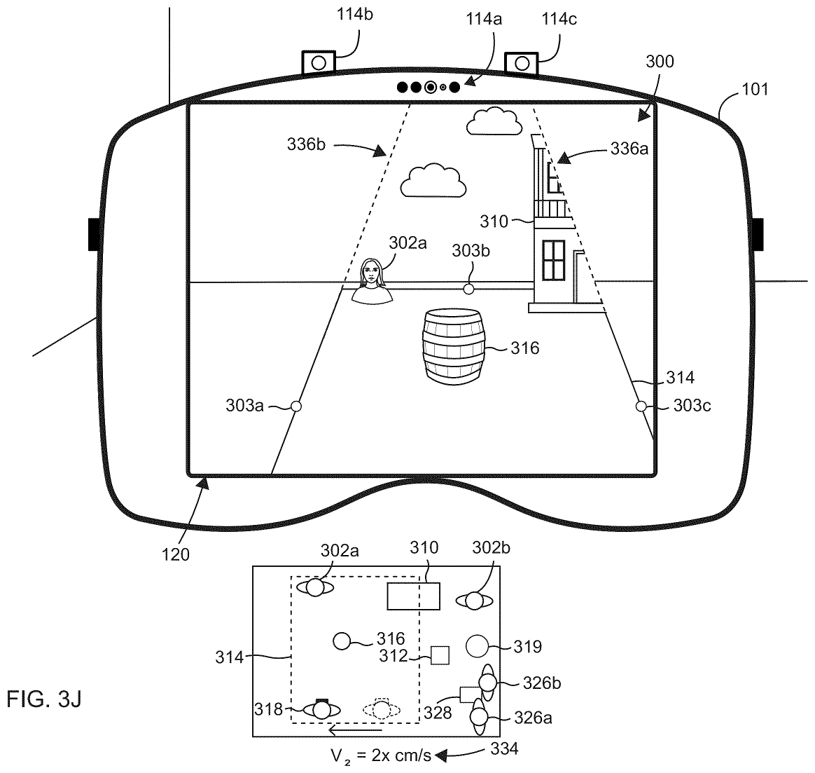

FIGS. 3A-3J illustrate example interactions with a virtual scene and a user's physical environment including inspection of a virtual scene in accordance with examples of the disclosure. It can be appreciated that the particular order of inputs, determinations, presentation of information, and other operations described with respect to FIGS. 3A-3J are merely exemplary, and that examples in which the order of execution of such operations can be different from as expressly described are also contemplated without departing from the scope of the present disclosure.

FIG. 3A illustrates an example device displaying a virtual scene in accordance with some examples of the disclosure. In FIG. 3A, three-dimensional environment 300 includes a virtual scene that itself includes a plurality of virtual objects and/or textures, the virtual scene displayed via display 120 of electronic device 101. In some examples, an electronic device displays a virtual scene that entirely replaces a view of the physical environment, as though the user were physically within a physical equivalent of the virtual scene. In some examples, display of the virtual scene replacing the view of the user's physical environment can correspond to displaying the virtual scene with a level of immersion greater than a threshold level of immersion, the level(s) of immersion described further herein. In some examples, in response to detecting a change in the user's viewpoint (e.g., changes to the user's position and/or orientation) in the physical environment, the electronic device can change the perspective view of the virtual scene, as though the user were changing positions within the virtual scene. In FIGS. 3A-3J, three-dimensional environment 300 is illustrated from the perspective of the electronic device 101, and additionally from an overhead perspective in a glyph below the perspective of electronic device 101.

In some examples, the virtual scene is an immersive three-dimensional environment. For example, a user of electronic device 101 is able to physically move throughout their physical environment (including areas of the physical environment illustrated beyond the extremities of a housing of electronic device 101 in FIG. 3A), and device 101 optionally updates a simulated perspective of a virtual sky, virtual floor, objects in response to detecting changes of the user's viewpoint (e.g., the user's position and/or orientation relative to their physical environment), similar to a physical perspective of a physical sky, physical floor, and/or one or more physical objects as the user moves relative to their physical environment. In some examples, the virtual scene included in three-dimensional environment 300 optionally includes a simulated texture overlaying a physical representation of the floor of the user's physical environment, and/or a virtual floor having a simulated spatial profile (e.g., topography) that is different from that of the user's physical environment. Further, the virtual scene can include a simulated atmosphere, such as a virtual sky (e.g., simulating the lower atmosphere at dawn, daylight hours, dusk, nighttime hours, and the like). It is understood that the virtual scene can be any suitable computer generated environment without departing from the scope of the disclosure. In FIG. 3A, the user's physical environment is illustrated beyond extremities of a housing of electronic device 101.

In some examples, the virtual scene is displayed as though occupying one or more regions of the user's physical environment. The physical environment—illustrated in FIG. 3A outside of a housing of electronic device 101—can include a physical room that the user 318 occupies. In some examples, the virtual scene can be displayed, by display 120, at least partially replacing a view of a representation of the user's physical environment, thus “consuming” a view of the physical environment. For example, electronic device 101 can include one or more outward facing cameras that obtain images of the user's physical environment, and the images can be displayed via display 120 as if the user were able to view the physical environment directly, without the assistance of electronic device 101. At least a portion or all of such a view of the physical environment can be displayed at corresponding positions of display 120 and with a level of opacity less than a threshold level (e.g., 0, 1, 5, 10, 15, 20, 25, 30, 35, 40, 45, or 50% opacity), and the virtual scene can be displayed at those corresponding positions with a level of opacity greater than a threshold level of opacity (e.g., 0, 1, 5, 15, 25, 40, 50, 60, 65, 75, 90, or 100% opacity). Additionally or alternatively, in some examples, portions of the physical environment can be visible through a transparent portion of the display without the display actively displaying those portions of the physical environment.

In some examples, the physical environment of user 318 can include one or more physical objects in the user's environment, physical individuals in the user's environment, physical walls, a physical floor, and the like. In some examples, the electronic device 101 can present representations of the user's physical environment. For example, the virtual scene included in three-dimensional environment 300 in FIG. 3A can be displayed with an at least partial degree of translucency, overlaying a representation and/or view of the user's physical environment (e.g., images collected by sensors 114a-c of the user's physical environment) presented via display 120. In some examples, presenting the three-dimensional environment 300 includes displaying virtual content and/or presenting a view of the user's physical environment (e.g., via passive optical passthrough including a lens and/or a partially or entirely transparent sheet of material such as glass). In some examples, a representation of the user's physical environment includes one or more images of the user's physical environment. In some examples, the electronic device 101 displays a real-time, or nearly real-time stream of images (e.g., video) of one or more portions of the physical environment corresponding to a “representation” of the user's physical environment.

As described previously, the virtual scene can include one or more virtual objects in some examples of the disclosure. The virtual objects can include digital assets modeling physical objects, virtual placeholder objects (e.g., polygons, prisms, and/or simulated two or three-dimensional shapes), virtual objects including user interfaces for applications (e.g., stored in memory by electronic device 101), and/or other virtual objects that can be displayed within a VR, XR, and/or MR environment. As an example, three-dimensional environment 300 includes barrel 316, which optionally is a virtual asset displayed within the virtual scene at a simulated position similar to a physical position and orientation of a physical barrel relative to a viewpoint of user 318. Similarly, crate 312 is included in three-dimensional environment, at a different simulated position and/or orientation than the position and/or orientation of barrel 316. In FIG. 3A, building 310 is also included in the virtual scene, which is also a virtual asset (e.g., virtual building) having a position and orientation relative to the virtual scene and/or the viewpoint of user 318. It is understood that a greater number, a fewer number, and/or alternative objects can be displayed without departing from the scope of the disclosure.

In some examples, the electronic device 101 concurrently displays the virtual border and/or boundary described previously concurrently with the virtual scene. For example, boundary 314 is displayed in FIG. 3A, which includes a plurality of lines forming a rectangular border overlaying a floor of the virtual scene. In some examples, the boundary 314 is displayed with visual properties, such as with a color, brightness, saturation, opacity, hue, simulated lighting and/or glowing effect mimicking the visual appearance of a light source illuminating the virtual scene, and/or a width to distinguish boundary 314 from three-dimensional environment 300. In some examples, the virtual border includes a greater or fewer number of sides than the shape shown in FIG. 3A. For example, the virtual border is optionally triangular, pentagonal, circular, elliptical, and/or any other suitable polygonal shape and/or set of curves. In some examples, the virtual border is volumetric, occupying one or more portions of the virtual floor and/or one or more portions of the virtual scene above the virtual floor. As an example, the boundary 314 is optionally a sphere, cube, rectangular prism, and/or another suitable volumetric shape, optionally including a visually distinguished one or more edges.

In some examples, the electronic device 101 can display boundary 314 concurrently with one or more visual objects that function to change one or more dimensions of the boundary 314. For example, object 303a is optionally a virtual “grabber” that the user 318 can direct input toward (e.g., gaze, a voice command, an air gesture (e.g., an air pinch including one or more contacts of a plurality of fingers of the user, an air pointing of one or more fingers, and air clenching of one or more fingers), contact with a trackpad, and/or selection with a stylus) object 303a. In response to receiving the input directed to object 303a, the electronic device 101 can initiate a scaling of boundary 314 in a first dimension, and by a first magnitude corresponding to a direction and/or magnitude of the user input. Additionally or alternatively, the electronic device 101 can initiate a scaling of boundary 314 in a second, different direction in response to input directed to object 303b and can initiate scaling along the first dimension in a second direction in response to input directed to object 303c, as described further with reference to FIGS. 3A-3B. In some examples, the electronic device 101 displays additional or alternative virtual objects, and in response to input directed to the additional or alternative virtual objects, scales and/or translates the boundary 314 in one or more directions concurrently or in rapid succession.

In some examples, while a position and/or orientation of user 318 corresponds to a region of the three-dimensional environment 300 corresponding to the virtual scene, the electronic device 101 displays the virtual scene with a first visual appearance. As an example, turning back to FIG. 3A, the location of the user 318 in the three-dimensional environment 300 is entirely within the area of the three-dimensional environment 300 bound by boundary 314, which optionally bounds and corresponds to a region of the user's physical environment. Accordingly, for example, the electronic device 101 displays the virtual scene with a first level of immersion (e.g., full immersion, in which the virtual scene replaces any representation of the user's physical environment). Accordingly, for example, the user as illustrated in FIG. 3A cannot currently see physical objects that may be in their physical environment. In some examples, before initiating display of the virtual scene, the electronic device 101 displays boundary 314 overlaying a representation (e.g., image(s) and/or video) of the user's physical environment, prompting user 318 to remove physical objects from the region of three-dimensional environment 300 bounded by boundary 314. In FIG. 3A, the electronic device 101 displays the virtual sky, the virtual floor, and the virtual objects described previously at a relatively high level of opacity (e.g., 100% opacity).

In some examples, electronic device 101 displays one or more representations of individuals other than user 318 via display 120. For example, representations 302a and 302b are included in three-dimensional environment 300 in FIG. 3A, representative of other individuals that are virtually or physically included in the user's three-dimensional environment 300. As an example, representations 302a and/or 302b optionally are expressive avatars, such as anthropomorphic avatars, having one or more body parts that can move relative to each other. The body parts optionally include a head, hand(s), arm(s), shoulder(s), a neck, leg(s), finger(s), toe(s), facial features, and the like. In some examples, the representations 302a and/or 302b can correspond to individuals that share the user's physical environment, such as individuals that are in the user's physical room. In some examples, representation 302a and/or 302b are presented via a passive optical passthrough (e.g., a lens, a transparent material, and/or directly visible to the eyes of the user), and correspond to a view of their respective, corresponding physical users. Representation 302b as illustrated includes a plurality of body parts, as an example of a fully expressive avatar or a representation of a physical individual sharing the user's 318 physical environment. Representation 302a as illustrated in FIG. 3A includes a partially expressive avatar or representation of a user of an electronic device that is not physically sharing the physical environment of user 318. It is understood that such representations are merely exemplary, and that additional or alternative representations of users of corresponding electronic devices can be included in three-dimensional environment 300, and that representation 302a can have one or more characteristics similar to or the same as those described with reference to representation 302b, and vice-versa.

In some examples, the representations 302a and/or 302b can correspond to individuals that are not in the user's physical environment but are represented using spatial information. In some examples, electronic device 101 uses the spatial information to map portions of the physical environment of user 318 to portions of the virtual scene, and/or to map portions of the physical environments of the individuals corresponding to representations 302a and/or 302b to the portions of the virtual scene. As an example, a communication session between electronic device 101, a first electronic device used by a first user represented by representation 302a, and a second electronic device used by a second user represented by representation 302b can be ongoing to facilitate the mapping between physical environments of respective users of respective electronic devices. In some examples, the communication session includes communication of information corresponding to real-time, or nearly real-time communication of sounds detected by the electronic devices (e.g., speech, sounds made by users, and/or ambient sounds). In some examples, the communication session includes communication of information corresponding to real-time, or nearly real-time movement and/or requests for movement of representations (e.g., avatars) corresponding to users participating in the communication session.

For example, the first electronic device can detect movement of a user corresponding to representation 302a in the physical environment of the user (e.g., different from the physical environment of user 318) and can communicate information indicative of that movement with the electronic devices participating in the communication session, including electronic device 101. Prior to detecting the movement, the first electronic device can display the virtual scene relative to a viewpoint of the first electronic device (e.g., a position and/or orientation relative to the virtual scene, similar to a physical position and/or orientation of the user relative to a physical equivalent of the virtual scene). In response to detecting the movement (e.g., obtaining information indicative of the movement from the other electronic device), the first electronic device can update the viewpoint of the user of the first electronic device in accordance with the physical movement (e.g., in a direction, and/or by a magnitude of movement) to an updated viewpoint, as though the user of the first electronic device were physically moving through a physical equivalent of the virtual scene. It can be appreciated that requests for such movement can be directed to an input device (e.g., a virtual joystick, a trackpad, a physical joystick, a virtual button, a physical button, and/or another suitable control) in addition to or in the alternative to detecting physical movement of the user. Electronic device 101 can receive such information, and in response, can move the representation 302a relative to the virtual scene by a magnitude and/or direction of movement that mimics the physical movement of the user of the first electronic device relative to the physical environment of the user of the first electronic device. It is understood that other electronic devices—such as an electronic device corresponding to representation 302b and/or electronic device 101—can also detect similar inputs described with reference to the first electronic device, and cause movement of their corresponding representation within the virtual scene.

It is also understood that movement and/or placement of representations of users participating in the communication session can be defined relative to a shared coordinate system, rather than strictly relative to virtual dimensions of the virtual scene. For example, the electronic device 101 can present a view of the physical environment of user 318 not including a virtual scene, and can display representations 302a and 302b at positions within the view of the physical environment and/or movement of the representations 302a and 302b within the view of the physical environment. It is understood that the examples described with respect to FIGS. 3A-3J can occur during a communication session (described herein), and that information communicating positions, orientations, audio, and/or other aspects of physical users and/or information provided by physical users can be exchanged via the communication session to devices participating in the communication session. It is understood that dependent upon context, the operations described with reference to virtual content being displayed relative to the virtual scene can be displayed relative to a representation of the user's physical environment, such as visual indications of attention of the user 318 described below.

In some examples, electronic device 101 displays one or more visual indications indicating user attention within three-dimensional environment 300. For example, electronic device 101 detects a virtual position of a target of the user's attention 306 (e.g., gaze), and displays a visual indication 304c at the virtual position, thus presenting a visual indication of the portion of three-dimensional environment 300 that the user's attention is targeting. In some examples, the target of the user's attention is indicated using one or more portions of the user's body other than the eyes. For example, although not shown in FIG. 3A, electronic device 101 can detect a spatial relationship between a point of contact between one or more fingers included in hand 308 (e.g., forming an air pinching gesture or an air pointing gesture) and electronic device 101. The spatial relationship can be based upon a ray cast from a portion of electronic device 101, such as a center of electronic device 101, through the portions of the user's body (e.g., through the air pinch gesture, through a fingertip arranged in an air pointing gesture), and extending toward a position within the virtual scene.

In some examples, attention of representation 302a is detected and/or information indicative of a target of attention is obtained, and electronic device 101 displays a visual indication of the attention in response to the detection and/or obtaining. In accordance with a determination that attention of a user is directed to a portion of the virtual scene that is not visible (e.g., as though a physical user is gazing at a portion of a physical crate in the physical environment of the user corresponding to representation 302a that the user 318 cannot see from their perspective), electronic device 101 forgoes display of a representation of attention of representation 302a. Additionally or alternatively, electronic device 101 can display a visual indication of attention with a modified appearance (e.g., a different spatial profile such as a simulated glow surrounding a portion of crate 312, an arrow with a simulated depth curving behind crate 312, and/or with visual characteristics (e.g., opacity, blurring, saturation, and/or a simulated lighting effect)) to convey that a target of attention of the user corresponding to representation 302a is not currently visible to user 318. It is understood that the visual indications of attention can be displayed, and are at times omitted from the figures for convenience. For example, a visual indication of representation 302b in FIG. 3B directed to building 310 is displayed in FIG. 3A, but can alternatively be not displayed (e.g., in accordance with a determination that the user corresponding to representation 302b prohibits sharing of a visual indication of their attention).

In some examples, the virtual scene has a simulated depth, and the visual indication 304c is displayed at a position in accordance with the user's attention and/or the spatial relationship between the device 101 and the air gesture. As an example, electronic device 101 in FIG. 3A displays visual indication 304c at a position on a surface of the virtual floor included in the virtual scene due to the user's gaze, and/or the ray projected from device 101 through the air pinch gesture intersecting with the position on the virtual floor.

In some examples, as described herein, electronic device 101 can display indications of attention of the other users. For example, in FIG. 3A, attention (e.g., gaze) of a user corresponding to representation 302a is directed to the virtual floor. The electronic device of that user can detect that the floor is the target of the user's attention, and can communicate information indicative of that target to electronic device 101. In response to obtaining the information, electronic device 101 can display a visual indication of attention, such as visual indication 304a in FIG. 3A. Similarly, an electronic device corresponding to representation 302b can detect attention of a user corresponding to representation 302b, and can display a visual indication of the user's attention such as visual indication 304b in FIG. 3A overlaying building 310. It is understood that in some examples, in response to detecting information that the attention of a corresponding user has changed relative to the three-dimensional environment 300 and/or the virtual scene, corresponding electronic devices can communicate information moving the attention indicative of an updated target of attention. In response to obtaining such updated information, electronic device 101 can move the visual indication of attention (e.g., move visual indication 304a and/or visual indication 304b) in accordance with the updated information to an updated position and/or orientation relative to content included in the virtual scene. In some examples, the visual indication(s) of attention are displayed overlaying representations of the physical environment of user 318 (e.g., not including a portion of the virtual scene).

In some examples, electronic device 101 selectively displays the visual indication of attention (e.g., visual indication 304c in FIG. 3A). For example, when an interaction mode relative to the virtual scene is enabled (e.g., an editing mode), electronic device 101 can display the visual indication of attention. In some examples, when the interaction mode is disabled, the electronic device forgoes display of the visual indication of attention. Similarly, while the interaction mode is enabled, electronic device 101 can display other visual indications of attention of other users (e.g., visual indication(s) 304a and/or 304b in FIG. 3A), and while the interaction mode is disabled, the electronic device 101 can forgo display of the visual indications of attention of the other users. In some examples, electronic device 101 displays the visual indication(s) of attention in accordance with user preference. For example, a user setting specified by electronic device 101 can permit or prohibit sharing of visual indications of attention of user 318 with other users participating in a communication session with electronic device 101. In some examples, the visual indication of attention can be displayed in response to detecting an express request to display the visual indication (e.g., a predefined air gesture performed by the user's body, a pose of one or more portions of the user's body, a verbal request to display the visual indication, and/or selection of a virtual and/or physical control (e.g., button, slider, and/or menu options)) within three-dimensional environment 300 and/or to share the visual indication with other devices participating in the communication session with electronic device 101.

FIG. 3B illustrates presentation of the virtual scene while a user of an electronic device is at a location corresponding to partially beyond a border of a virtual scene in accordance with some examples of the disclosure. From FIG. 3A to FIG. 3B, user 318 moves rightward relative to the overhead view of three-dimensional environment 300. As illustrated in the overhead view and from the perspective of three-dimensional environment visible via the electronic device 101, the viewpoint of user 318 straddles the boundary 314 in FIG. 3B, optionally as a result of the aforementioned movement. In some examples, the electronic device 101 initiates display of representations of portions the electronic device's physical environment in accordance with a determination that the viewpoint of user 318 satisfies one or more criteria, such as a criterion satisfied when the viewpoint of the user corresponds to a position associated with the boundary 314. As an example, the one or more criteria include respective criterion satisfied when the viewpoint of user 318 coincides with a position defining boundary 314, when the viewpoint is within a threshold distance of a position defining boundary 314 (e.g., 0.01, 0.05, 0.075, 0.1, 0.25, 0.4, 0.5, 1, or 1.5 m) of the boundary 314, and/or when the viewpoint of the user recently moved to the aforementioned positions within a threshold period of time (e.g., 0.01, 0.05, 0.1, 0.5, 1, or 1.5 seconds).

In FIG. 3B, boundary 320 illustrates a delineation between the virtual scene and the representations of the user's physical environment. For example, in FIG. 3B, the electronic device 101 projects a dividing line from the boundary 314 (e.g., toward a ceiling of three-dimensional environment 300), maintaining display of portions of the virtual scene that are within the boundary 314. As an example, building 310 is partially displayed, and barrel 316 is fully displayed due to their respective positions relative to boundary 314. In FIG. 3B, the representation 302b of another user present in the physical environment of the electronic device 101 is presented near a physical corner of a room included in three-dimensional environment 300. For example, although such positions are beyond the boundary 314 and/or a projection of boundary 314 (e.g., to a ceiling of the user's environment), the electronic device 101 presents representation 302b because representation 302b corresponds to a representation of a user (e.g., not a virtual asset included in the virtual scene and/or a physical object) in the physical environment of the electronic device 101. Additionally, in FIG. 3B, table 319 corresponds to a representation (e.g., image and/or video, such as real-time video or a view of the table through a transparent portion of display generation component 120 and/or electronic device 101) of a physical table that was previously not visible while the user 318 was within boundary 314. Thus, as illustrated in FIG. 3B, one or more portions of the virtual scene continue to be displayed at their respective positions and/or orientations relative to three-dimensional environment 300 and/or the viewpoint of the user 318 that are within the boundary 314, and one or more second portions of the virtual scene beyond boundary 314 are replaced with one or more representations of the user's physical environment at one or more second regions of three-dimensional environment 300 in response to the viewpoint of the user satisfying one or more criteria (e.g., movement of the viewpoint satisfying the one or more criteria).

In some examples, in accordance with a determination that the viewpoint of user 318 moves entirely beyond boundary 314, the electronic device 101 ceases display of the virtual scene. For example, in response to movement of the user 318 to a position that is not straddling and/or within a threshold distance of boundary 314, the electronic device 101 optionally ceases display of all virtual objects and/or textures included in the virtual scene, and optionally initiates presentation of a representation of the user's physical environment (e.g., images and/or video of the user's physical environment and/or a view of portions of the physical environment through a transparent portion of display generation component 120 and/or electronic device 101). In some examples, the boundary 314 continues to be displayed independently of the viewpoint of user 318, provided position(s) of one or more lines defining the boundary 314 are within a viewport of the user. In some examples, the boundary 314 is displayed when the viewpoint of user 318 corresponds to and/or is within the boundary 314. In some examples, the boundary 314 is displayed when the viewpoint of user 318 is within a threshold distance of the boundary 314 (e.g., and the virtual scene is displayed, or the virtual scene is not displayed). In some examples, the boundary 314 is displayed in response to an express request to display the boundary such as user input including a voice command, a selection of a physical or virtual button, a depression of an electromechanical crown button, an air gesture, and/or some combination of one or more of the aforementioned modalities of input.

FIG. 3C illustrates an expansion of a border associated with a virtual scene and an increase in immersion of the virtual scene. From FIG. 3B to FIG. 3C, the electronic device 101 detects an input directed to object 303c requesting a scaling of boundary 314 while attention 306 is directed to virtual object 303c, and in response, changes a first dimension of boundary 314. For example, from FIG. 3B to FIG. 3C, the electronic device can detect an air pinch or air pointing, and/or movement of hand 308 while the air pinch (e.g., contact between fingers) or air point (e.g., pose of one or more fingers) is maintained. In response to detecting the air pinch or air point, the electronic device 101 scales boundary 314 by a first magnitude and in a first direction based on a second magnitude of the movement of the air gesture in a second direction that is optionally the same as the first direction.

For example, the electronic device 101 expands the rectangular-shaped boundary 314 to assume a position to the right of the user's viewpoint in response to rightward movement of the user's hand 308. In FIG. 3C, the user 318 is entirely within a region of the three-dimensional environment 300 bound by the expanded boundary 314. Accordingly, the viewpoint of user 318 satisfies one or more criteria again (similar to satisfaction of criteria in FIG. 3A), such as a criterion satisfied when the viewpoint of user 318 corresponds to the region of three- dimensional environment 300 within boundary 314. Thus, in response to the expansion of boundary 314, the electronic device 101 displays the virtual scene entirely consuming the viewport of the electronic device 101 in FIG. 3C, replacing presentation of representations of the user's physical environment that would otherwise be visible if the virtual scene were not displayed. As an example, crate 312 is again displayed in FIG. 3C because the virtual crate is included in the virtual scene, its position now consumed by virtual content and not consumed by a representation of the user's physical environment. Further, table 319—previously visible as illustrated in FIG. 3B—is no longer included in three-dimensional environment 300 in FIG. 3C. In some examples, a representation of a user is displayed independently of the representation's spatial relationship with the boundary 314. For example, in both FIGS. 3B and 3C, representation 302b is displayed, thus maintaining the user's visibility of the representation independently of the viewpoint of user 318 relative to boundary 314. As described previously, representation 302b optionally corresponds to a presentation of a physical user via a transparent material included in the display 120 and/or the electronic device 101, and/or optionally corresponds to an at least partially virtual avatar representative of the user that does not share a physical environment with user 318.

In some examples, the electronic device 101 determines a component of movement of hand 308 in a first direction, and scales the boundary 314 in accordance with the component of movement of the hand 308 that is parallel relative to a permitted scaling direction associated with the object 303c (e.g., rightward or leftward scaling of a right edge of boundary 314). In such examples, the electronic device 101 can forgo scaling of the boundary 314 in accordance with movement of hand 308 that is not parallel to the permitted scaling direction. Although not shown, in response to detecting leftward movement of hand 308 while the attention 306 of the user is directed to object 303c, the electronic device 101 optionally scales boundary 314 in accordance with the leftward movement, thus decreasing an area and/or volume of the boundary 314. In some examples, in accordance with a determination that an object associated with scaling boundary 314 is associated with scaling of boundary 314 along a plurality of dimensions (e.g., a depth and/or width of the border relative to the viewpoint of user 318 in FIG. 3B), the electronic device 101 scales the boundary 314 in accordance with user input in a plurality of directions. For example, the electronic device 101 optionally displays an object in a corner of boundary 314 that is interactive to scale the two sides of the border that meet in the corner, thus enabling the user to scale the border in the two directions of the two sides with one or more inputs directed to the object in the corner.

In FIG. 3D, an electronic device displays a visual indication of physical individuals within a physical environment of the user while maintaining display of a virtual scene in accordance with some examples of the disclosure. For example, the viewpoint of user 318 in FIG. 3D is different from the viewpoint of the user in FIG. 3C, including a different position and/or orientation. In FIG. 3D, the viewpoint of user 318 remains corresponding to (e.g., within) the boundary 314 of the virtual scene. Thus, the electronic device 101 maintains display of the virtual scene, as illustrated the display of crate 312 in FIG. 3D, and/or the virtual sky including clouds. In FIG. 3D, three-dimensional environment 300 further includes visual indication 322. In some examples, the visual indication 322 indicates a region of the user's physical environment in which the electronic device 101 might expect physical individuals to occupy. For example, the region is optionally occupied with equipment including computing workstations, laptop computers, servers, additional media recording equipment, tables, chares, and one or more people operating such equipment. Such equipment is optionally capable of communication with the electronic device 101, other devices in communication with electronic device 101, and/or optionally is engaged in the communication session described previously including electronic device 101. In some examples, the position of the visual indication 322 is fixed relative to three-dimensional environment 300 (e.g., cannot be moved in response to a request by the user 318). In some examples, the position of visual indication 322 is not necessarily fixed, but is not moved in response to one or more user inputs that are operative to move other virtual content (e.g., virtual objects, the boundary 314, and/or user interfaces of applications and/or settings associated with the electronic device 101). For example, the electronic device 101 updates the position of visual indication 322 in response to detecting movement of the equipment associated with physical individuals described above.

In some examples, the electronic device 101 displays a representation of a portion of the user's physical environment in response to user input directed to visual indication 322. For example, in FIG. 3D, the electronic device 101 detects an air gesture performed by hand 308 and/or attention 306 of the user directed to visual indication 322. In response to detecting the air gesture, electronic device 101 unveils a representation (e.g., images and/or video) of the region of the physical environment corresponding to visual indication 322, as shown in FIG. 3E. Thus, the electronic device 101 concurrently displays the virtual scene and a portion of the user's physical environment, independent of the user's viewpoint relative to boundary 314, in response to the user input directed to visual indication 322 in FIG. 3D. In FIG. 3E, the representation of the physical environment includes a representation 326a and representation 326b, including images and/or video such as real-time video of people in the portion of the user's physical environment, and table 328 corresponding to a representation of a physical table.

FIGS. 3E-3H illustrate examples of an electronic device prohibiting or permitting modification of the virtual scene based upon spatial relationships between users participating in a communication session with the electronic device and a boundary associated with the virtual scene. In some examples, the electronic device 101 forgoes modification of the virtual scene—such as forgoing of insertion of a virtual asset—in accordance with a determination that a user is within the boundary 314. In FIG. 3E, the electronic device 101 detects user input including an air gesture (e.g., an air pinch performed by hand 308) requesting insertion and/or display of a virtual asset within the virtual scene. It is noted, however, that the position of representation 302a is within the boundary 314 when the user input is detected in FIG. 3E. Consequentially, from FIG. 3E to FIG. 3F, the electronic device 101 forgoes display of a virtual barrel that was requested by user 318 corresponding to the air gesture performed by hand 308 in FIG. 3E. It is understood that additional or alternative input(s) can be detected, and operation(s) associated with modification of the virtual scene forgone, in accordance with a determination that a representation of a user is within the boundary 314 when the additional or alternative input(s) are detected.

In FIG. 3G, the electronic device 101 detects representation 302a at a position outside of the boundary 314 of the virtual scene. For example, the electronic device 101 detects information and/or movement of representation 302a and/or a user corresponding to the representation 302a from the location shown in FIG. 3F to the location shown in FIG. 3G, and in response, moves the representation 302a to an updated position outside of the boundary 314 in accordance with the information and/or detected movement. In FIG. 3G, the electronic device 101 detects user input including an air gesture performed by hand 308—similar or identical to the user input described with reference to FIG. 3E—and in response, the electronic device 101 displays barrel 330 in FIG. 3H. In FIG. 3H, the electronic device 101 permits insertion of barrel 330 into the virtual scene in response to receiving the input in accordance with a determination that the users other than 318 do not correspond to positions within the boundary 314, and/or in accordance with a determination that the users are more than a threshold distance away from a requested position of insertion of barrel 330. From the perspective of the user corresponding to representation 302a in FIG. 3H, for example, the physical environment of the user is visible, and the virtual scene shared in the communication session with the electronic device 101 is not visible when barrel 330 is initially displayed because the location of the user corresponding to representation 302a is not associated with boundary 314.

FIGS. 31 and 3J illustrate examples of presenting visual representations of the physical environment of a user of an electronic device 101 in accordance with a determination that the viewpoint of the user satisfies one or more criteria. In some examples, in accordance with a determination that the viewpoint of user 318 changes at a rate faster than a threshold rate, the electronic device 101 displays a representation of the physical environment of the user. From FIG. 3A to FIG. 31, for example, user 318 translates their viewpoint leftward as illustrated in the overhead view. In some examples, because the velocity 332 is less than a threshold velocity (e.g., “V=x cm/s”), and/or because the viewpoint of user 318 is at a position corresponding to (e.g., within) boundary 314, the electronic device 101 maintains display of the virtual scene and forgoes display of the representation of the user's physical environment. From FIG. 3A to FIG. 3J, the viewpoint of user 318 translates to the same position as the position illustrated in FIG. 3I, at a velocity 334 that is greater than the velocity 332 of the user from FIG. 3A to FIG. 3I (e.g., at “V=2x cm/s in FIG. 3J). From FIG. 3A to FIG. 3J, because the rate of change of the viewpoint is greater than a threshold (e.g., 0.05, 0.1, 0.5, 1, 2, 5, 7.5, 10, 12.5, 15, or 20 cm/s), the electronic device 101 displays representations of the user's physical environment beyond the boundaries 336a and 336b, which can be projections of the dimensions of boundary 314 toward a ceiling of the user's three-dimensional environment 300. In some examples, in response to detecting the velocity of the user's position above the threshold amount, the electronic device 101 displays the portions of the physical environment even if the location of the user corresponds to the boundary 314 as described herein for the duration of the movement.

In some examples, the movement of the viewpoint of the user is rotational (e.g., relative to an axis extending vertically through the head of the user, horizontally and/or parallel to the floor of the user and in a perceived lateral direction, and/or along a depth axis extending parallel to the floor and in front/behind the viewpoint of the user), and the electronic device 101 displays representations of the user's physical environment in response to detecting rotation at a rate greater than a threshold rate. In some examples, the movement of the viewpoint of the user is translational in a different direction (e.g., different from leftward or rightward movement illustrated in FIGS. 31 and 3J) relative to the overhead view of three-dimensional environment 300, and the electronic device displays representation of the user's physical environment in response to detecting translation at a rate greater than a threshold rate. In some examples, the portions of the viewport which are no longer consumed by the virtual scene in response to movement of the viewpoint of user 318 are not strictly associated with the dimensions of boundary 314. For example, the boundary 336a and boundary 336b can correspond to portions (e.g., 5, 10, 15, 25, 40, 50, 60, 75, 80, 85, or 90%) of the user's viewport relative to an edge of the viewport (e.g., a vertical and/or lateral edge). Additionally or alternatively, the virtual scene can be maintained in a first portion of the viewport of the user in response to movement that satisfies one or more criteria (e.g., a circular, rectangular, and/or elliptical portion of the viewport) and/or representations of the user's physical environment can be displayed in a second portion of the viewport (e.g., beyond the boundary of the first portion of the viewport).

It is understood that, similar to as described further herein with reference to displaying representations of the user's physical environment relative to boundary 314, a visual appearance of the virtual scene and/or the representations of the user's physical environment can be different than as illustrated in FIGS. 3J and/or 3I. For example, the representations of the user's physical environment can increase in opacity relative to the three-dimensional environment 300 and/or the virtual scene can decrease in opacity relative to the three-dimensional environment 300 in response to the movement of the user's viewpoint that satisfies one or more criteria (e.g., when moving faster than a threshold speed). Additionally or alternatively, a color, saturation, brightness, hue, and/or simulated lighting effect can be applied to, modified, and/or ceased overlaying the representation of the user's physical environment and/or the virtual scene in response to the movement that satisfies the one or more criteria.

Attention is now directed to inputs and operations directed to and associated with inserting virtual objects into a virtual scene, such as in virtual objects inserted into the virtual scene based in part on a determined context of the user's interaction with the virtual scene. In some examples, one or more user inputs as described at least further below are detected by electronic device 101, and in response, the electronic device 101 performs one or more operations inserting, moving, modifying, and/or visually distinguishing one or more virtual objects. In some examples,

As described with reference to FIG. 2, electronic device 101 includes and/or communicates one or more sensors to detect a spatial relationship between the user's viewpoint, the one or more portions of the user's body, and the virtual scene. For example, electronic device 101 optionally casts one or more rays from the one or more sensors, intersecting with the one or more portions of the user's body, and further intersecting with one or more portions of the virtual scene. In some examples, electronic device 101 detects that user input is being directed to one or more portions of the virtual scene in accordance with a determination that the one or more rays correspond to (e.g., virtually intersect with) the one or more portions of the virtual scene. In some examples, the one or more portions of the user's body include one or more fingers, portion of the fingers, palms, hands, wrists, forearms, and/or arms of the user. In some examples, electronic device 101 detects and/or determines a position and/or orientation of a plurality of the aforementioned one or more body parts, and determines a target of user input in accordance with a combination of the positions and/or orientations of the plurality of one or more body parts.

In some examples, the one or more user inputs include attention of the user. For example, electronic device 101 in FIG. 3G detects a position and/or orientation of one or more eyes of the user (e.g., indicative of gaze of user 318) using one or more imaging sensors such as one or more cameras included in sensors 114a-c. In some examples, the electronic device 101 detects a position and/or orientation of one or more rays projected from the one or more eyes of the user to respective one or more positions within three-dimensional environment 300. In some examples, electronic device 101 detects user input to the respective one or more positions that correspond to (e.g., intersect or are near) the one or more rays projected from the one or more eyes of the user.

In some examples, the one or more user inputs include speech of the user. Audio provided by the user optionally includes one or more words spoken by the user that are detected by one or more microphones included in and/or in communication with electronic device 101. In some examples, electronic device 101 parses and/or communicates information to one or more external computing devices to determine a content of the user's speech, including identifying the user's words and/or obtaining a semantic understanding of the speech. For example, electronic device includes one or more processors that are configured to perform natural language processing to detect one or more words and determine a likely meaning of a sequence of the one or more words. In some examples, the electronic device 101 additionally or alternatively determines the meaning of the sequence of the one or more words based upon a determined context of the user.

In some examples, electronic device 101 determines a context of the user's interaction with three-dimensional environment 300. For example, electronic device 101 determines the user's context-partially or entirely—based upon the position and/or orientation of visual indication 304c when an input is detected. For example, because the user's attention is directed to object 303c when an air gesture (e.g., pinch and/or point) is detected in FIG. 3B, electronic device 101 initiates a scaling of boundary 314. In some examples, user context is determined using additional or alternative factors. For example, in the absence of an air pinch gesture including contact between the user's fingers, electronic device 101 can display a virtual object at a position corresponding to where the target of attention is directed in response to detecting a user input requesting placement of the annotation. As an example, audio provided by user 318 detected in FIG. 3G optionally is parsed by electronic device 101 to determine that user 318 is likely referring to crate 312, because the user references moving “this crate” while crate 312 is the only virtual object resembling a physical crate. Thus, electronic device 101 optionally determines that user context in FIG. 3D corresponds to a “crate” or a crate-like virtual object, and optionally determines that crate 312 corresponds to the crate of interest. Thereafter, the electronic device 101 can detect subsequent commands to move and/or modify dimensions and/or an appearance of the crate 312, and in response, can change the crate 312 in accordance with the detected commands. In some examples, the voice commands can request insertion of a virtual object such the barrel 330 in FIG. 3H, and in response to the voice commands, can display the virtual barrel 330.

In some examples, either in response to, concurrently occurring with, and/or after insertion of a virtual object into the virtual scene, electronic device 101 detects and/or prompts user 318 for information corresponding to an annotation and/or description of the virtual object. For example, electronic device 101 displays a user interface prompting the user to provide speech, air gesture(s), text entry (e.g., via a virtual or physical keyboard), movement, attention, and/or other suitable modalities of information. Such a user interface can include one or more virtual buttons to initiate text entry, recordings of voice, recordings of movement, and/or recordings of the user's attention, and/or to cease such text entry and/or recordings. In some examples, the information provided by user 318 includes a description associated with the virtual object, a name of the virtual object, metadata associated with the virtual objects such as a category of the virtual object, and/or other suitable information that a future inspector of the virtual object might be interested in. After text entry and/or recordings provided by the user 318 are complete, electronic device 101 can cease display of the user interface and/or associate the provided information with a corresponding virtual object. In some examples, electronic device 101 begins recording and/or initiates text entry without display of a dedicated user interface in response to insertion of the virtual object.

In some examples, electronic device 101 can map user speech to virtual objects and/or requests to insert virtual object into particular positions within the virtual scene in accordance with a determination that the user speech describes an object that is similar to a virtual object and/or a position related to the virtual object. For example, speech referring to a box, a rectangular prism, a cuboid, a container, a basket (e.g., if the virtual object includes an opening on at least one side of crate 312), and the like can be determined to correspond to crate 312. Additionally, speech referencing a name assigned to crate 312 can be detected (e.g., “crate 1”) and determined to correspond to crate 312 in FIG. 3H. In such example(s), electronic device 101 can interpret the pronoun “this” object as a virtual object that the user 318 directed their attention to within a threshold amount of time (e.g., 0, 0.01, 0.05, 0.1, 0.5, 1, 1.5, 2, 3, 5, 10, or 30 seconds), a physical object that the user physically gestured toward (e.g., pointing at, moving their fingers and/or hands toward, moving their lips toward the virtual object, leaning their head toward the virtual object, moving their arm toward the virtual object, and/or pointing their leg and/or foot toward the virtual object), and/or a virtual object that is within a threshold distance (e.g., 0, 0.01, 0.05, 0.1, 0.5, 1, 1.5, or 3 m) of the user. Similarly, speech referencing a cask, cylinder, drum, barrel, tub, and/or keg can be determined to correspond to barrel 330 in FIG. 3H. It is understood that additional or alternative factors can be contemplated without departing from the scope of the disclosure. For example, speech indicating “that,” “these,” “those,” “the object over there,” and the like can be detected by electronic device 101, and mapped to one or more virtual objects in accordance with determinations of user context. Additionally, based upon factors that are similar to or the same as described with reference to referring to a particular virtual object, the electronic device 101 can detect that the user 318 is requesting insertion and/or display of the virtual object to a particular position within the virtual scene, and in response can insert the virtual object into the virtual scene.

In some examples, electronic device 101 can determine user context in accordance with movement, indications of attention, and/or other factors. For example, in FIG. 3H, in response to detecting movement, attention, and/or speech of the user corresponding to representation 302a, the electronic device corresponding to representation 302a can communicate information indicating the detected movement, attention, and/or speech. In response to detecting that information, the electronic device corresponding representation 302a can initiate a spatial recording, storing and/or capturing information to later present an animation and/or audio recording including the user's movement, speech, and/or indication of attention. In such examples, the recording can be initiated without detecting an express input (e.g., an actuation of a virtual or physical button, a voice command, an air gesture, and/or another suitable input as described further herein) or can be initiated in response to the express input. For example, the electronic device can detect that the user began talking about crate 312, is looking at crate 312, and/or is moving around and/or within a threshold distance of crate 312, and determine that the user's context relates to crate 312. The recording can continue until the electronic device detects a ceasing of speech, a pause in speech, a movement of a distance beyond a threshold distance from crate 312, a change in attention away from crate 312, and/or until an input (e.g., an express input) requesting ceasing of the recording is detected. Information indicative of the recording can be communicated to other electronic devices in real-time, after the recording is concluded, and/or in response to the ceasing of the recording. In response to obtaining such information associated with the recording, electronic device 101 can display virtual annotation such within the virtual scene, which can later be interacted with as described further herein to initiate presentation of a spatial representation of the user's speech, indication of attention, and/or presentation of audio included in the recording, optionally concurrently.

In some examples, one or more factors indicative of user context (e.g., speech, air gesture(s), air pose(s), gaze, previous interactions with the three-dimensional environment 300, and the like) can be used in combination to determine a likely set of one or more virtual objects that are a likely target of annotation. The electronic device 101, for example, can use gaze in conjunction with speech, can disregard one or more factors associated with user context (e.g., an air gesture overriding gaze and/or speech), and/or can probabilistically determine user context based on placement (e.g., display) of previous virtual objects in view of previous determinations of user context.

In some examples, user context can be determined to be generic, and not expressly referencing a virtual object within the three-dimensional environment. In some examples, electronic device 101 can determine that a reminder is generally directed to the virtual scene, and does not expressly refer to a particular virtual object. Electronic device 101 can determine that audio provided by user 318 generally refers to a plurality of portions of the virtual scene (e.g., scene textures can correspond to a virtual texture overlaying a floor of the virtual scene, one or more textures applied to one or more virtual objects, and/or a virtual texture overlaying a virtual sky included in three-dimensional environment 300). Accordingly, electronic device 101 can display a virtual object within three-dimensional environment 300 in response to determining the user context is generally directed to the virtual scene. A generically placed annotation such as virtual object can be displayed at a predetermined virtual distance (e.g., 0, 0.01, 0.05, 0.1, 0.5, 1, 1.5, or 3m) of the viewpoint of user 318, and/or relatively centered with the viewpoint of user 318.

In some examples, user context is determined to be generic and/or directional, such as “to my left,” “to my right,” “in front of me,” and/or in a simulated cardinal direction as specified by user speech. In such examples, electronic device 101 can display a virtual object in accordance with a determination of a meaning of the user's speech. For example, electronic device 101 can parse the user's speech, determine a relative portion of three-dimensional environment 300 that the speech can refer to relative to a viewpoint of user 318 when the speech is received, and display and/or place a virtual object a predetermined distance from the viewpoint of user 318 toward the relative portion of the three-dimensional environment in response to detecting the speech. For example, discussion of the virtual scene linked to the user's left optionally is mapped to portions of the three-dimensional environment 300 to a left of a center of the user's viewpoint. Electronic device 101 can place a virtual object at a predetermined distance, and left of the center of the user's viewpoint in response to detecting such discussion. Additionally or alternatively, discussion of the virtual scene linked to the user's right optionally can be mapped to portions of the three-dimensional environment 300 to a right of the center of the user's viewpoint. In response to detecting speech indicating a portion of the virtual scene “to the user's right,” electronic device 101 can place the virtual object at the predetermined distance, optionally towards the right of the center of the user's viewpoint. It is understood additional or alternative directions relative to the user's viewpoint and/or simulated cardinal directions can be included as factors in determining user context and/or in placement of the virtual objects (e.g., behind the user's viewpoint, “north” of the user's viewpoint, and/or above or below what is visible via the viewport while the user 318 has a particular viewpoint).

In some examples, in accordance with a determination that information is obtained including a request to insert a virtual object at a position in the virtual scene not presently visible to user 318, electronic device 101 presents spatial feedback indicating the position of the requested annotation. For example, the spatial feedback includes audio generated with one or more characteristics to mimic the perception of a physical audio source placed at a physical equivalent of the position of the requested virtual object in the user's physical environment playing audio feedback (e.g., a chime, speech, and/or another notification noise). In some examples, the spatial feedback additionally or alternatively includes a visual indication, such as a simulated glowing effect illuminating one or more portions of the user's viewport, the one or more portions close to and/or generally toward the position of the requested virtual object.

In some examples, the position of an inserted virtual object is expressly indicated by movement of the user. For example, electronic device 101 can detect attention and/or an air gesture (e.g., pinch) directed toward a vacant position within a virtual floor of the virtual scene. In response, the electronic device 101 can display the virtual object that was requested at the vacancy on the virtual floor. In some examples, a virtual object is displayed at a position in accordance with user context, such as speech. In some examples, electronic device 101 determines a position and/or an orientation of the virtual annotations in accordance with a determination of the user's context and/or in accordance with virtual content included the virtual scene. For example, virtual objects can be displayed pointing downwards toward a virtual floor and/or portion of the virtual scene, which optionally can be a default orientation of such virtual objects. In some examples, the orientation of an inserted virtual object can be varied based upon surrounding virtual content. For example, in accordance with a determination that a requested virtual object would obscure another virtual object, electronic device 101 can display the requested virtual object with an orientation and/or position different from a default orientation and/or translated away from a default position.

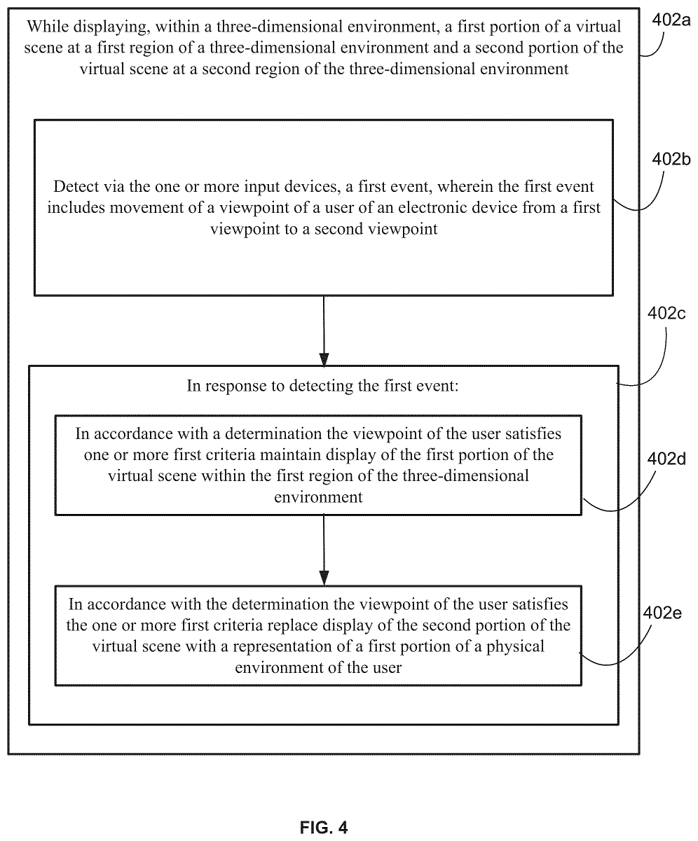

FIG. 4 illustrates a flow diagram illustrating an example process for interactions including annotation, editing, and inspection of a virtual scene in accordance with examples of the disclosure. In FIG. 4, a method 400 can be performed at an electronic device in communication with one or more inputs devices and a display. In some examples, while displaying, within a three-dimensional environment, a first portion of a virtual scene at a first region of the three-dimensional environment and a second portion of the virtual scene at a second region of the three-dimensional environment, the electronic device detects (402a), via the one or more input devices, a first event, wherein the first event includes movement of a viewpoint of a user of the electronic device from a first viewpoint to a second viewpoint. In some examples, in response to detecting the first event (402b), and in accordance with a determination the viewpoint of the user satisfies one or more first criteria (402c), the electronic device maintains (402d) display of the first portion of the virtual scene within the first region of the three-dimensional environment, and replaces (402e) display of the second portion of the virtual scene with a representation of a first portion of a physical environment of the user.

The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some examples, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some examples, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone).

A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some examples a representation of a physical environment (e.g., displayed via virtual passthrough or optical passthrough) can be partially or fully obscured by a virtual environment. In some examples, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some examples, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed.

In some examples, a level of immersion includes an associated degree to which the virtual content displayed by the electronic device (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some examples, the background content is included in a background over which the virtual content is displayed (e.g., background content in the representation of the physical environment). In some examples, the background content includes user interfaces (e.g., user interfaces generated by the electronic device corresponding to applications), virtual objects (e.g., files or representations of other users generated by the electronic device) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the electronic device does not obscure/prevent visibility of them through the display generation component). In some examples, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency.

In some examples, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some examples, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some examples, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the electronic device and makes the user-device interface more efficient.

Therefore, according to the above, some examples of the disclosure are directed to a method, comprising, at an electronic device in communication with a display and one or more input devices, while displaying, within a three-dimensional environment, a first portion of a virtual scene at a first region of the three-dimensional environment and a second portion of the virtual scene at a second region of the three-dimensional environment, detecting, via the one or more input devices, a first event, wherein the first event includes movement of a viewpoint of a user of the electronic device from a first viewpoint to a second viewpoint. In some examples, in response to detecting the first event, and in accordance with a determination the viewpoint of the user satisfies one or more first criteria, maintaining display of the first portion of the virtual scene within the first region of the three-dimensional environment, and replacing display of the second portion of the virtual scene with a representation of a first portion of a physical environment of the user.

Additionally or alternatively, in some examples, the method can comprise, in response to detecting the first event, and in accordance with a determination that the viewpoint of the user does not satisfy the one or more first criteria, maintaining display of the first portion of the virtual scene within the first region of the three-dimensional environment, maintaining display of the second portion of the virtual scene within the second region of the three-dimensional environment.

Additionally or alternatively, in some examples, the one or more first criteria include a criterion that is satisfied when the movement of the viewpoint to the second viewpoint of the user corresponds to movement beyond a border surrounding one or more portions of the virtual scene including the first portion of the virtual scene.

Additionally or alternatively, in some examples, the method can comprise, while the viewpoint of the user is the first viewpoint, displaying a first view of the virtual scene, and in response to the first event, the displaying a second view of the virtual scene.

Additionally or alternatively, in some examples, the method can comprise, while displaying the virtual scene within the three-dimensional environment, displaying, via the display, a border between the first region of the three-dimensional environment and the second region of the three-dimensional environment.

Additionally or alternatively, in some examples, the border is displayed before the first event is detected and is displayed while the first portion of the virtual scene is displayed at the first region of the three-dimensional environment and while the second portion of the virtual scene is displayed at the second region of the three-dimensional environment. ‘

Additionally or alternatively, in some examples, the method can comprise, while displaying the second portion of the virtual scene including the representation of the first portion of the physical environment of the user, detecting, via the one or more input devices, an indication of one or more inputs requesting a change in one or more dimensions of the border. In some examples, the method can further comprise, in response to detecting the indication of the one or more inputs updating the one or more dimensions of the border in accordance with the indication of the one or more inputs, changing one or more dimensions of the first region of the three-dimensional environment including the virtual scene in accordance with the indication, and changing one or more dimensions of the second region of the three-dimensional environment including the representation of the physical environment of the user in accordance with the indication.

Additionally or alternatively, in some examples, the virtual scene is shared in a communication session between the electronic device and another electronic device different from the electronic device. In some examples, the method can further comprise, while the communication session is ongoing, obtaining, via the one or more input devices, an indication of a request to modify virtual content included in the virtual scene. In some examples, the method can further comprise, in response to obtaining the indication of the request to modify the virtual content, in accordance with a determination that one or more second criteria are satisfied, modifying the virtual content in accordance with the indication of the request to modify the virtual content, and in accordance with a determination that the one or more second criteria are not satisfied, forgoing the modifying of the virtual content.

Additionally or alternatively, in some examples, the method can further comprise, while the first portion of the physical environment of the user is visible, displaying, via the display, a representation of a participant corresponding to the other electronic device within the first portion of the physical environment of the user, wherein the one or more second criteria include a criterion that is satisfied when a position of the representation of the participant corresponds to a position within the representation of the first portion of the physical environment of the user.

Additionally or alternatively, in some examples, the method can further comprise, while the first portion of the physical environment of the user is visible, displaying, via the display, a representation of a participant corresponding to the other electronic device at a position within the first portion of the virtual scene, wherein the one or more second criteria include a criterion that is satisfied when the position of the representation of the participant is different from one or more positions corresponding to where the virtual content is modified.

Additionally or alternatively, in some examples, the virtual scene is shared in a communication session between the electronic device and another electronic device, different from the electronic device. In some examples, the method can further comprise, while the communication session is ongoing, in accordance with a determination that one or more characteristics of the other electronic device satisfy one or more second criteria, including a representation of a participant of the communication session that is using the other electronic device within the three-dimensional environment, and in accordance with a determination that one or more characteristics of the other electronic device do not satisfy the one or more second criteria, forgoing inclusion of the representation of the participant within the three-dimensional environment.

Additionally or alternatively, in some examples, the one or more characteristics of the other electronic device satisfies the one or more second criteria when the other electronic device is a head-mounted electronic device.

Additionally or alternatively, in some examples, the one or more characteristics of the other electronic device do not satisfy the one or more second criteria when the other electronic device is any one of a laptop computing device, a mobile handset, a tablet computing device, and a desktop computing device.

Additionally or alternatively, in some examples, the representation of the physical environment of the user is displayed consuming a portion of a viewport of the electronic device.

Additionally or alternatively, in some examples, the first event includes movement of the viewpoint of the user satisfies the one or more criteria when the viewpoint changes from the first viewpoint to the second viewpoint at a rate greater than a threshold rate.

Additionally or alternatively, in some examples, the first portion of the physical environment of the user corresponds to a respective portion of the three-dimensional environment within which one or more representation of physical individuals are displayed.

Additionally or alternatively, in some examples, the method can further comprise, before the first event is detected and while the viewpoint of the user is the first viewpoint, displaying, via the display, a visual indication corresponding to the first portion of the physical environment of the user.

Additionally or alternatively, in some examples, the first portion of the physical environment of the user is a world-locked relative to the physical environment of the user.

Additionally or alternatively, in some examples, the method can further comprise, while the first portion of the physical environment of the user is visible, in response to the first event, and in accordance with the determination that the viewpoint of the user satisfies the one or more first criteria, displaying, via the display, one or more representations of physical individuals within the representation of the first portion of the physical environment of the user.

Additionally or alternatively, in some examples, before detecting the first event, while displaying the first portion of the virtual scene at the first region of the three-dimensional environment, and while displaying the second portion of the virtual scene at the second region of the three-dimensional environment, detecting, via the one or more input devices, a second event including user input directed to the second portion of the virtual scene, and in response to detecting the second event, replacing display of the second portion of the virtual scene with the representation of the first portion of the physical environment of the user.

Some examples of the disclosure are directed to an electronic device in communication with a display and one or more input devices, the electronic device comprising, one or more processors, memory, and one or more programs stored in the memory, wherein the one or more programs are configured to be executed by the one or more processors, the one or more programs including instructions to perform a method comprising, while displaying, within a three-dimensional environment, a first portion of a virtual scene at a first region of the three-dimensional environment and a second portion of the virtual scene at a second region of the three-dimensional environment, detecting, via the one or more input devices, a first event, wherein the first event includes movement of a viewpoint of a user of the electronic device from a first viewpoint to a second viewpoint, and in response to detecting the first event, and in accordance with a determination the viewpoint of the user satisfies one or more first criteria, maintaining display of the first portion of the virtual scene within the first region of the three-dimensional environment, and replacing display of the second portion of the virtual scene with a representation of a first portion of a physical environment of the user.

Some examples of the disclosure are directed to a non-transitory computer readable storage medium storing one or more programs, the one or more programs comprising instructions, which when executed by one or more processors of an electronic device in communication with a display and one or more input devices cause the electronic device to perform a method comprising, while displaying, within a three-dimensional environment, a first portion of a virtual scene at a first region of the three-dimensional environment and a second portion of the virtual scene at a second region of the three-dimensional environment, detecting, via the one or more input devices, a first event, wherein the first event includes movement of a viewpoint of a user of the electronic device from a first viewpoint to a second viewpoint, and in response to detecting the first event, and in accordance with a determination the viewpoint of the user satisfies one or more first criteria, maintaining display of the first portion of the virtual scene within the first region of the three-dimensional environment, and replacing display of the second portion of the virtual scene with a representation of a first portion of a physical environment of the user.

Some examples of the disclosure are directed to an electronic device comprising one or more processors, memory, and one or more programs stored in the memory and configured to be executed by the one or more processors, the one or more programs including instructions for performing a method as described herein.

Some examples of the disclosure are directed to a non-transitory computer readable storage medium storing one or more programs, the one or more programs comprising instructions, which when executed by one or more processors of an electronic device, cause the electronic device to perform a method as described herein.

Some examples of the disclosure are directed to an electronic device, comprising, one or more processors, memory, and means for performing a method as described herein.

Some examples of the disclosure are directed to an information processing apparatus for use in an electronic device, the information processing apparatus comprising a means for performing a method as described herein.

The foregoing description, for purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the invention and its practical applications, to thereby enable others skilled in the art to best use the invention and various described examples with various modifications as are suited to the particular use contemplated.

What is claimed is:

1. A method comprising:
at an electronic device in communication with a display and one or more input devices:
while displaying, within a three-dimensional environment, a first portion of a virtual scene at a first region of the three-dimensional environment and a second portion of the virtual scene at a second region of the three-dimensional environment, detecting, via the one or more input devices, a first event, wherein the first event includes movement of a viewpoint of a user of the electronic device from a first viewpoint to a second viewpoint; and
in response to detecting the first event, and in accordance with a determination the viewpoint of the user satisfies one or more first criteria:
maintaining display of the first portion of the virtual scene within the first region of the three-dimensional environment; and
replacing display of the second portion of the virtual scene with a representation of a first portion of a physical environment of the user.

2. The method of claim 1, further comprising:
in response to detecting the first event, and in accordance with a determination that the viewpoint of the user does not satisfy the one or more first criteria:
maintaining display of the first portion of the virtual scene within the first region of the three-dimensional environment; and
maintaining display of the second portion of the virtual scene within the second region of the three-dimensional environment.

3. The method of claim 1, wherein the one or more first criteria include a criterion that is satisfied when the movement of the viewpoint to the second viewpoint of the user corresponds to movement beyond a border surrounding one or more portions of the virtual scene including the first portion of the virtual scene.

4. The method of claim 1, further comprising:
while the viewpoint of the user is the first viewpoint, the electronic device displays a first view of the virtual scene; and
in response to the first event, the electronic device displays a second view of the virtual scene.

5. The method of claim 1, further comprising, while displaying the virtual scene within the three-dimensional environment:
displaying, via the display, a border between the first region of the three-dimensional environment and the second region of the three-dimensional environment.

6. The method of claim 5, wherein the border is displayed before the first event is detected and is displayed while the first portion of the virtual scene is displayed at the first region of the three-dimensional environment and while the second portion of the virtual scene is displayed at the second region of the three-dimensional environment.

7. The method of claim 5, further comprising:
while displaying the second portion of the virtual scene including the representation of the first portion of the physical environment of the user, detecting, via the one or more input devices, an indication of one or more inputs requesting a change in one or more dimensions of the border; and
in response to detecting the indication of the one or more inputs:
updating the one or more dimensions of the border in accordance with the indication of the one or more inputs;
changing one or more dimensions of the first region of the three-dimensional environment including the virtual scene in accordance with the indication; and
changing one or more dimensions of the second region of the three-dimensional environment including the representation of the physical environment of the user in accordance with the indication.

8. The method of claim 1, wherein the virtual scene is shared in a communication session between the electronic device and another electronic device different from the electronic device, the method further comprising:
while the communication session is ongoing:
obtaining, via the one or more input devices, an indication of a request to modify virtual content included in the virtual scene;
in response to obtaining the indication of the request to modify the virtual content:
in accordance with a determination that one or more second criteria are satisfied, modifying the virtual content in accordance with the indication of the request to modify the virtual content; and
in accordance with a determination that the one or more second criteria are not satisfied, forgoing the modifying of the virtual content.

9. The method of claim 8, further comprising:
while the first portion of the physical environment of the user is visible, displaying, via the display, a representation of a participant corresponding to the other electronic device at a position within the first portion of the virtual scene, wherein the one or more second criteria include a criterion that is satisfied when the position of the representation of the participant is different from one or more positions corresponding to where the virtual content is modified.

10. The method of claim 1, wherein the virtual scene is shared in a communication session between the electronic device and another electronic device, different from the electronic device, the method further comprising:
while the communication session is ongoing:
in accordance with a determination that one or more characteristics of the other electronic device satisfy one or more second criteria, including a representation of a participant of the communication session that is using the other electronic device within the three-dimensional environment; and
in accordance with a determination that one or more characteristics of the other electronic device do not satisfy the one or more second criteria, forgoing inclusion of the representation of the participant within the three-dimensional environment.

11. The method of claim 10, wherein the one or more characteristics of the other electronic device satisfies the one or more second criteria when the other electronic device is a head-mounted electronic device.

12. The method of claim 10, wherein the one or more characteristics of the other electronic device do not satisfy the one or more second criteria when the other electronic device is any one of a laptop computing device, a mobile handset, a tablet computing device, and a desktop computing device.

13. The method of claim 1, wherein the representation of the physical environment of the user is displayed consuming a portion of a viewport of the electronic device.

14. The method of claim 1, wherein the first event including movement of the viewpoint of the user satisfies the one or more first criteria when the viewpoint changes from the first viewpoint to the second viewpoint at a rate greater than a threshold rate.

15. The method of claim 1, wherein the first portion of the physical environment of the user corresponds to a respective portion of the three-dimensional environment within which one or more representation of physical individuals are displayed.

16. The method of claim 15, further comprising:
before the first event is detected and while the viewpoint of the user is the first viewpoint, displaying, via the display, a visual indication corresponding to the first portion of the physical environment of the user.

17. The method of claim 15, further comprising:
while the first portion of the physical environment of the user is visible, in response to the first event, and in accordance with the determination that the viewpoint of the user satisfies the one or more first criteria, displaying, via the display, one or more representations of physical individuals within the representation of the first portion of the physical environment of the user.

18. The method of claim 15, further comprising:
before detecting the first event, while displaying the first portion of the virtual scene at the first region of the three-dimensional environment, and while displaying the second portion of the virtual scene at the second region of the three-dimensional environment, detecting, via the one or more input devices, a second event including user input directed to the second portion of the virtual scene; and
in response to detecting the second event, replacing display of the second portion of the virtual scene with the representation of the first portion of the physical environment of the user.

19. An electronic device in communication with a display and one or more input devices, the electronic device comprising:
one or more processors;
memory; and
one or more programs stored in the memory, wherein the one or more programs are configured to be executed by the one or more processors, the one or more programs including instructions to perform a method comprising:
while displaying, within a three-dimensional environment, a first portion of a virtual scene at a first region of the three-dimensional environment and a second portion of the virtual scene at a second region of the three-dimensional environment, detecting, via the one or more input devices, a first event, wherein the first event includes movement of a viewpoint of a user of the electronic device from a first viewpoint to a second viewpoint; and
in response to detecting the first event, and in accordance with a determination the viewpoint of the user satisfies one or more first criteria:
maintaining display of the first portion of the virtual scene within the first region of the three-dimensional environment; and
replacing display of the second portion of the virtual scene with a representation of a first portion of a physical environment of the user.

20. A non-transitory computer readable storage medium storing one or more programs, the one or more programs comprising instructions, which when executed by one or more processors of an electronic device in communication with a display and one or more input devices cause the electronic device to perform a method comprising:
while displaying, within a three-dimensional environment, a first portion of a virtual scene at a first region of the three-dimensional environment and a second portion of the virtual scene at a second region of the three-dimensional environment, detecting, via the one or more input devices, a first event, wherein the first event includes movement of a viewpoint of a user of the electronic device from a first viewpoint to a second viewpoint; and
in response to detecting the first event, and in accordance with a determination the viewpoint of the user satisfies one or more first criteria:
maintaining display of the first portion of the virtual scene within the first region of the three-dimensional environment; and
replacing display of the second portion of the virtual scene with a representation of a first portion of a physical environment of the user.
